(19) United States
(12) Patent Application Publication
(10) Pub. No.: US 2021/0199130 A1
(43) Pub. Date: Jul. 1, 2021

(54) Anti-fall Ceiling Fan

(71) Applicant: Fujian Huada Electric Co., Ltd, Fujian (CN)

(72) Inventor: Nai Hua Xiao, Fujian (CN)

(21) Appl. No.: 16/728,054

(22) Filed: Dec. 27, 2019

(51) Int. Cl. F04D 29/64; F16M 13/02

(52) U.S. Cl. CPC F04D 29/646; F16M 13/027

(57) ABSTRACT

An anti-fall ceiling fan includes a hanging structure, a fan body and an anti-fall structure. The hanging structure is connected to a high position of a building by a fixed frame; the fan body is installed under the hanging structure, and a fixed shaft is connected to the fixed frame; the anti-fall structure includes two connecting plates, a pallet and a stop plate, and the two connecting plates are connected to the fixed frame and have a connecting wing extending from the bottom of the connecting plates, and the pallet is disposed around the top of a bearing unit of the fan body, and a through hole is formed at the center of the pallet for passing the fixed shaft without contact, and a gap exists between the pallet and the connecting plate; the stop plate is fixed to the connecting wing securely, and a through hole is formed at the center of the stop plate for passing the bearing unit without contact, and the stop plate is disposed under the pallet and spaced from the pallet with a gap, and the through hole formed at the center of the stop plate has an internal diameter smaller than the external diameter of the pallet.

### BACKGROUND OF THE INVENTION

### Field of the Invention

The present invention relates to an anti-fall ceiling fan, and more particularly to the anti-fall ceiling fan capable of enhancing the stability of hanging the ceiling fan and preventing a sudden fall of the fan that may hurt people or damage properties.

### Description of the Related Art

In general, a ceiling fan is installed to a high position of a building such as an indoor ceiling or a factory roof, and the ceiling fan is usually rotated clockwise or counterclockwise (viewing from below). For the ceiling fan that adopts the clockwise rotation, the airflow produced by the rotation of the ceiling fan blows (or pushes) air downward to produce wind below. If such ceiling fan is operated together with an air-conditioner, the indoor temperature can be reduced quickly and effectively. For the ceiling fan that adopts the counterclockwise rotation, the airflow produced by the rotation of the ceiling fan blows (pushes) air upward for the following two effects. If the internal environment of the building is in a high temperature (in a hot area), the counterclockwise rotation of the ceiling fan pushes the airflow upward to draw the hot air below to the upper part, and then send the hot air to the outside through a pipe channel (such as an exhaust fan) installed at an upper sidewall, so that the environment below can be cooled quickly. If the internal environment of the building is in a low temperature (in a cold area), the counterclockwise rotation of the ceiling fan will blow and sends the cold airflow upward to draw the cold air below to an upper place due to the principle of thermal rise and cold drop, and the indoor hot air will be trapped at the high place. Therefore, the counterclockwise rotation blows and draws the cold air below to the upper place, and the hot air above will be squeezed and pushed along the sidewall downward to the ground, so that the environment below will be distributed with hot air quickly to increase the temperature, which is conducive to the uniform indoor heat distribution in winter.

The ceiling fan is a common electric appliance, but the ceiling fan usually has a heavier weight, especially the industrial ceiling fan with large air flow and hung at a high place. Therefore, after a long period of use, the fixed shaft of the ceiling fan may break due to physical fatigue caused by frequent load and stress wear and may fall from the high position and hurt people or damage properties.

Obviously, the conventional ceiling fan hung at a high place has a potential risk of a sudden fall, which is really a hidden danger.

### SUMMARY OF THE INVENTION

In view of the drawbacks of the conventional ceiling fan hung at a high place which results in a potential danger of a sudden fall, the inventor of the present invention considers an improvement is necessary and proceed with an extensive research on improvement. The present invention is existing after a long-term effort.

Therefore, it is a primary objective of the present invention to provide an anti-fall ceiling fan capable of enhancing the hanging stability of the fan to prevent a sudden fall that may hurt people and damage properties.

To achieve the above-mentioned objective, the present invention is particularly related to an anti-fall ceiling fan, comprising a hanging structure, further comprising a fixed frame and two support plates, and the two support plates being symmetrically fixed to two outer sides of the fixed frame, and a lower section of the support plate being bent inwardly and then descended after the support plate passes through the bottom of the fixed frame; a fan body, installed at the bottom of the hanging structure, and having a driving structure disposed at the central position of the fan body and provided for driving the fan body to rotate, and the fan body having a fixed shaft extending upwardly from the center of the driving structure, and then being locked after the fixed shaft extends to a position between the lower sections of the two support plates, a bearing unit protruded from the center of the driving structure, a bearing unit disposed at the center of the inner bottom of the driving structure, and the two bearing units being disposed between the fixed shaft and the driving structure; and an anti-fall structure, comprising two connecting plates, a pallet, and a stop plate, and the two connecting plates being fixed to the outer sides of the two support plates respectively and each having a connecting wing extending outwardly; the pallet being disposed around the top of the bearing unit, and having a through hole formed at the center of the pallet and provided for passing the fixed shaft without contact, and a gap existed between the pallet and the connecting plate; the stop plate being locked to the connecting wing securely and having formed at the center of the stop plate and provided for passing the bearing unit extending from the top of the center of the driving structure without contact, and the stop plate being disposed under the pallet, and a gap being existed between the stop plate and the pallet, and the through hole formed at the center of the stop plate having an internal diameter smaller than the external diameter of the pallet.

According to the above-mentioned anti-fall ceiling fan, the two support plates have a through hole formed separately on both sides of the lower sections thereof, and a steel wire tied into each through hole, and the top of the steel wire is tied and fixed to a firm portion of a high position of a building.

According to the above-mentioned anti-fall ceiling fan, the upper section of the two connecting plates, the upper section of the two support plates, and the lower section of the fixed frame are attached and engaged with one another, and then a first bolt is provided for passing and locking the connecting plates, the support plates and the fixed frame.

According to the above-mentioned anti-fall ceiling fan, the fixed shaft and the lower section of the two support plates are attached and engaged with each other, and then a second bolt is provided for passing and locking the fixed shaft and the support plates.

According to the above-mentioned anti-fall ceiling fan, the two connecting wings and the stop plate are attached and engaged with each other, and then a third bolt is provided for passing and locking the connecting wings and the stop plate.

According to above-mentioned anti-fall ceiling fan, the pallet and the top of the bearing extending from the top of the center of the driving structure are attached and engaged with each other, and then a fourth bolt is used for passing and locking the pallet and the bearing unit.

Based on the description above, the through hole formed at the center of the stop plate has an internal diameter smaller than the external diameter of the pallet, so that if the fixed shaft is broken to cause the whole fan body to fall, the stop plate will immediately hold the pallet at the moment when the whole fan body falls, in order to stop the falling trend of the whole fan body. The present invention can prevent the fan body from falling, hurting people or damaging properties.

### BRIEF DESCRIPTION OF THE DRAWINGS

FIG. 1 is a perspective view of an embodiment of the present invention;

FIG. 1 is a perspective view of an embodiment of the present invention;

FIG. 2 is a cross-sectional view of an embodiment of the present invention;

FIG. 3 is a partial blowup view of FIG. 2;

FIG. 4 is a top view of a support plate connected to a steel wire in accordance with an embodiment of the present invention; and

FIG. 5 is a schematic view of a broken condition of a fixed shaft in accordance with an embodiment of the present invention; and

FIG. 6 is a partial blowup view of FIG. 5.

### DETAILED DESCRIPTION OF THE PREFERRED EMBODIMENTS

The present invention will become clearer in light of the following detailed description of an illustrative embodiment of this invention described in connection with the drawings.

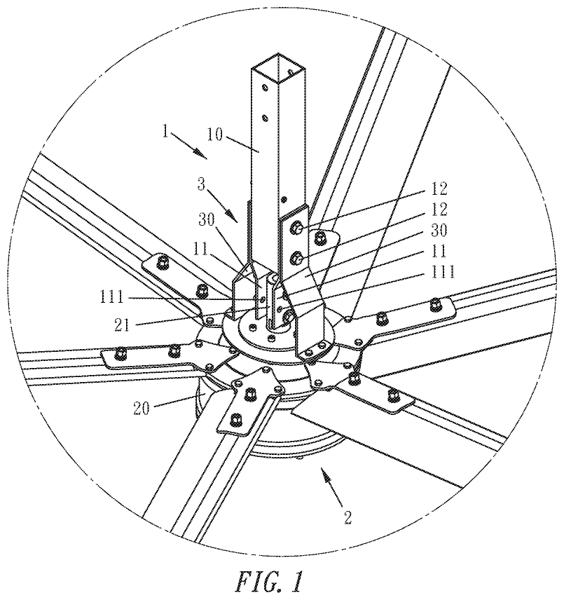

With reference to FIGS. 1 to 3 for an anti-fall ceiling fan of the present invention, the ceiling fan comprises:

a hanging structure 1, further comprising a fixed frame 10 and two support plates 11, and the two support plates 11 are symmetrically fixed to both outer sides of the fixed frame 10, and a lower section of the support plate 11 being bent inwardly and then descended after the support plates 11 pass through the bottom of the fixed frame 10;

a fan body 2, installed under the hanging structure 1, and having a driving structure 20 (wherein the casing of the driving structure 20 is shown in the figures, but the internal structure mainly including a rotor is not shown in the figures) disposed at the central position of the fan body 2, and provided for driving the fan body 2 to rotate, and the fan body 2 having a fixed shaft 21 extending upwardly from the center of the driving structure 20 into a lower section of the two support plates 11 and locked, and the driving structure 20 having a bearing unit 22 extending upwardly from the center thereof, and a bearing unit 23 disposed at the center of the inner bottom of the driving structure 20. In other words, the two bearing units 22, 23 are disposed between the fixed shaft 21 and the driving structure 20, to achieve the effect of driving the driving structure 20 to rotate the fan body 2 while keeping the fixed shaft 21 not to be rotated; and

an anti-fall structure 3, comprising two connecting plates 30, a pallet 31 and a stop plate 32, and the two connecting plates 30 being fixed to the outer sides and bottoms of the two support plates 11 and each having a connecting wing 33 extending to the outside outward; and the pallet 31 being disposed around the top of the bearing unit 22, and a through hole being formed at the center of the pallet 31 for passing the fixed shaft 21 without contact, and a gap being existed between the pallet 31 and the connecting plate 30; and the stop plate 32 being locked securely with the connecting wing 33, and a through hole being formed at the center of the stop plate 32 and provided for passing the bearing unit 22 without contact, and the stop plate 32 being disposed under the pallet 31, and a gap being existed between the stop plate 32 and the pallet 31.

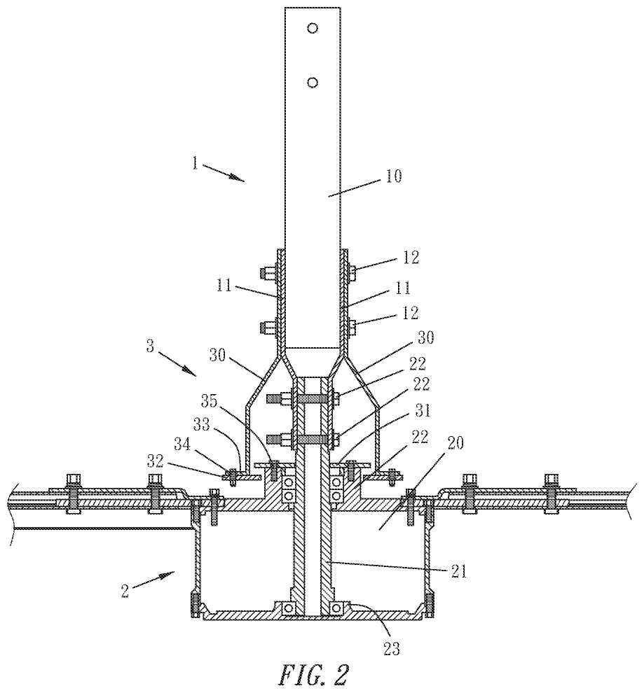

In FIG. 2, after the upper sections of the two connecting plates 30, the upper sections of the two support plates 11, and the lower section of the fixed frame 10 are attached and engaged with each other, a first bolt 12 is provided for passing and locking them securely.

In FIG. 2, the fixed shaft 21 and the lower section of the two support plates 11 are attached and engaged with each other, a second bolt 22 is provided for passing and locking them securely.

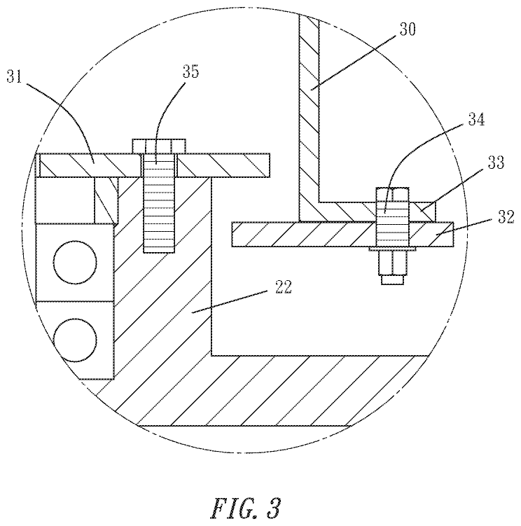

In FIGS. 2 and 3, after the two connecting wings 33 and the stop plate 32 are attached and engaged with each other, a third bolt 34 is provided for passing and locking them securely.

In FIG. 3, after the pallet 31 and the bearing unit 22 are attached and engaged with each other, a fourth bolt 35 is provided for passing and locking them securely.

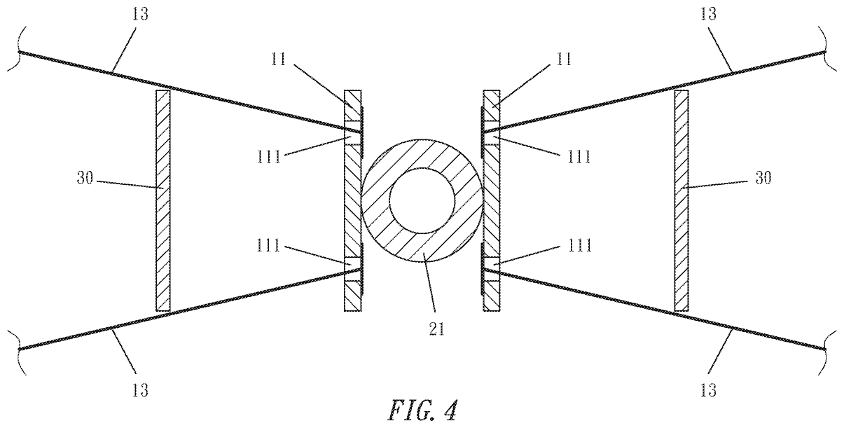

In FIGS. 1 and 4, a through hole 111 is formed separately on both sides of the lower section of the two support plates 11, and a steel wire 13 is tied in each through hole 111, and the top end of the steel wire 13 is tied properly and fixed to a firm portion (such as a beam) at a high place of a building to assist hanging the ceiling fan securely.

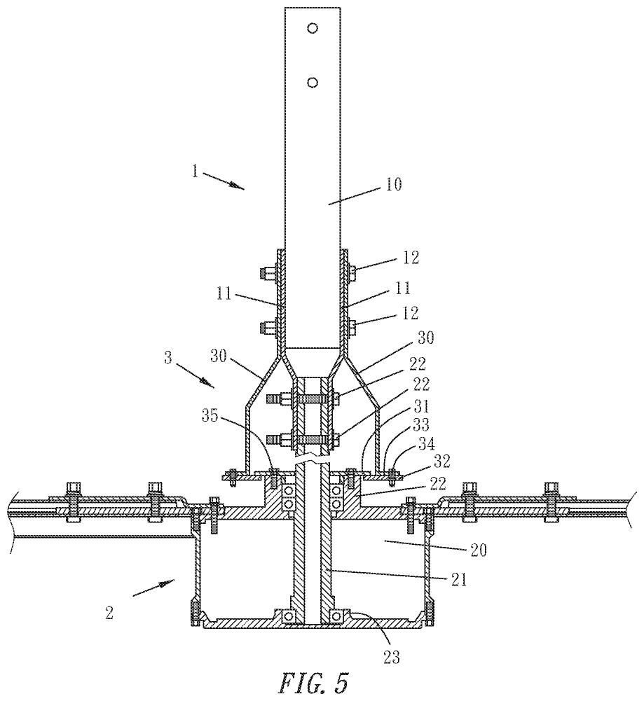

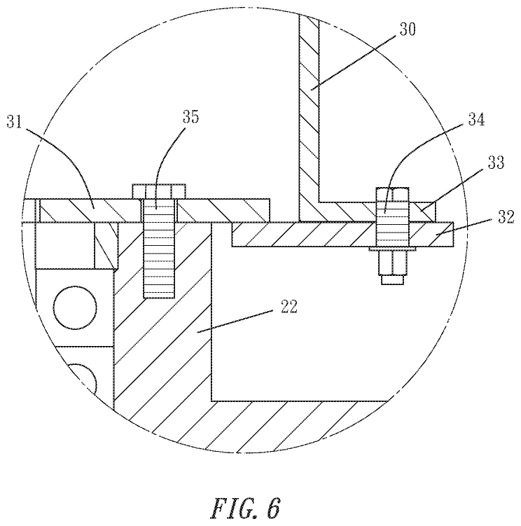

In FIGS. 5 and 6, if the fixed shaft 21 is broken suddenly due to a long period of loading and stress wear, (the broken line in FIG. 5 indicates that the fixed shaft 21 is broken) to cause a falling trend of the whole fan body 2, then the stop plate 32 will immediately hold the pallet 31 at the moment when the whole fan body 2 falls, in order to stop the falling trend of the whole fan body 2 (since the through hole formed at the center of the stop plate 32 has an internal diameter smaller than the external diameter of the pallet 31). This invention can prevent the fan body 2 from falling, hurting people and damaging properties.

In actual use, even if the present invention cannot prevent the fixed shaft 21 from being suddenly broken due to a long period of loading and wear and tear, the present invention still can hold the pallet 31 at the high position of the fan body 2 by the stop plate 32 at the moment when the fixed shaft 21 is broken, so as to immediately stop the falling trend of the whole the fan body 2.

The stop plate 32 has this effect because the stop plate 32 and the two connecting wings 33 have been already locked securely by the third bolt 34, and the two connecting wings 33 are extended upwardly into two connecting plates 30. In the meantime, the upper sections of the two connecting plates 30 and the lower section of the fixed frame 10 have already been locked securely by the first bolt 12, and the fixed frame 10 is fixed to the interior fixing facilities of the building, so that the stop plate 32 is a substantially unbreakable structure. As long as the stop plate 32 holds the pallet 31 immediately, the momentum for dropping the fan body 2 caused by gravity disappears instantly, so that the pallet 31 stays on the stop plate 32, and the people below can turn off the ceiling fan to stop the rotation of the fan body 2 easily, and a ladder may be used for repair and maintenance thereafter.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. An anti-fall ceiling fan, comprising:
a hanging structure, further comprising a fixed frame and two support plates, and the two support plates being symmetrically fixed to two outer sides of the fixed frame, and a lower section of the support plate being bent inwardly and then descended after the support plate passes through the bottom of the fixed frame;
a fan body, installed at the bottom of the hanging structure, and having a driving structure disposed at the central position of the fan body and provided for driving the fan body to rotate, and the fan body having a fixed shaft extending upwardly from the center of the driving structure, and then being locked after the fixed shaft extends to a position between the lower sections of the two support plates, a bearing unit protruded from the center of the driving structure, a bearing unit disposed at the center of the inner bottom of the driving structure, and the two bearing units being disposed between the fixed shaft and the driving structure; and
an anti-fall structure, comprising two connecting plates, a pallet, and a stop plate, and the two connecting plates being fixed to the outer sides of the two support plates respectively and each having a connecting wing extending outwardly; the pallet being disposed around the top of the bearing unit, and having a through hole formed at the center of the pallet and provided for passing the fixed shaft without contact, and a gap existed between the pallet and the connecting plate; the stop plate being locked to the connecting wing securely and having formed at the center of the stop plate and provided for passing the bearing unit extending from the top of the center of the driving structure without contact, and the stop plate being disposed under the pallet, and a gap being existed between the stop plate and the pallet, and the through hole formed at the center of the stop plate having an internal diameter smaller than the external diameter of the pallet.

2. The anti-fall ceiling fan of claim 1, wherein the two support plates have a through hole formed separately on both sides of the lower sections thereof, and a steel wire tied into each through hole, and the top of the steel wire is tied and fixed to a firm portion of a high position of a building.

3. The anti-fall ceiling fan of claim 1, wherein the upper section of the two connecting plates, the upper section of the two support plates, and the lower section of the fixed frame are attached and engaged with one another, and then a first bolt is provided for passing and locking the connecting plates, the support plates and the fixed frame.

4. The anti-fall ceiling fan of claim 1, wherein the fixed shaft and the lower section of the two support plates are attached and engaged with each other, and then a second bolt is provided for passing and locking the fixed shaft and the support plates.

5. The anti-fall ceiling fan of claim 1, wherein the two connecting wings and the stop plate are attached and engaged with each other, and then a third bolt is provided for passing and locking the connecting wings and the stop plate.

6. The anti-fall ceiling fan of claim 1, wherein the pallet and the top of the bearing extending from the top of the center of the driving structure are attached and engaged with each other, and then a fourth bolt is used for passing and locking the pallet and the bearing unit.
